(19) United States
(12) Patent Application Publication
(10) Pub. No.: US 2020/0211008 A1
(43) Pub. Date: Jul. 2, 2020

(54) SECURITY-ENHANCED WIRELESS COMMUNICATION APPARATUS

(71) Applicant: MUHANBIT CO., LTD., Seoul (KR)

(72) Inventors: Nam Seog HAN, Anyang-si (KR); Hee Won JUNG, Seoul (KR)

(73) Assignee: MUHANBIT CO., LTD., Seoul (KR)

(21) Appl. No.: 16/232,644

(22) Filed: Dec. 26, 2018

(51) Int. Cl. G06Q 20/40; H04W 12/08; H04W 4/10; H04W 4/70; H04L 29/08; G06F 9/455

(52) U.S. Cl. CPC G06Q 20/40; H04W 12/08; H04W 4/10; H04W 4/70; G06F 2009/45587; H04L 67/104; G06F 9/45533; G06F 2009/45595; H04L 67/06

(57) ABSTRACT

Disclosed is a security-enhanced wireless communication apparatus including: a memory divided into a plurality of security partitions; a security accelerator configured to provide a plurality of security algorithms; and a processor configured to controlling a plurality of security element adaptors, which provides security system call Application Programming Interfaces (APIs) respectively linked with independent security service applications, and a virtual machine, which enforces security policies with respect to the security system call APIs and provides an authority to use the security accelerator or an authority to access a corresponding security partition according to a corresponding security policy. Accordingly, a security solution specialized in multipurpose services may be provided using the virtual machine.

### BACKGROUND OF THE INVENTION

### Field of the invention

The present invention relates to a wireless communication technology and more particularly to a security-enhanced wireless communication apparatus capable of providing a security solution specialized in multiple purposes using a virtual machine.

### Related Art

A wireless Push-To-Talk (PTT) system may be used in a group of many people, that is, in an environment where members are required to use point-to-multipoint (PTM) communication. Examples of an environment where a PTT application is used include workgroup communications, security communications, construction site communication, and localized military communications. A PTT service corresponds to typical half-duplex, and only one member is allowed to transmit information to another member in a given time. Even the PTT service requires high-level security but has a very poor and vulnerable security function.

Korean Patent No. 10-0978987 (Aug. 24, 2010) relates to a method and an apparatus for rapid secure session establishment of half-duplex AD-hoc group voice cellular network channels and provides a scheme for security group communication in a wireless dispatch system including a device group, and the device group may include a first security device communicating with a plurality of second security devices via a channel.

Korean Patent No. 10-1048523 (Jul. 5, 2011) relates to a multifunctional walkie-talkie capable of implementing multiplex communication using a mobile phone via Bluetooth and receiving a radio signal, and configured to comprise a Push-To-Talk (PTT) switch additionally provided on an exterior of the walkie-talkie to enable wireless communication between a main body and the PTT switch, so that the walkie-talkie can be used efficiently when a user is enjoying a hand-using leisure sport (e.g., riding a bicycle, inline skates, a motorcycle, etc.), thereby significantly enhancing quality and reliability of the product and giving good impression to customers.

### RELATED ART DOCUMENTS

### Patent Documents

Korean Patent No. 10-0978987 (Aug. 24, 2010)

Korean Patent No. 10-1048523 (Jul. 5, 2011)

### SUMMARY OF THE INVENTION

An embodiment of the present invention provides a security-enhanced wireless communication apparatus capable of providing a security solution specialized in multipurpose services using a virtual machine.

An embodiment of the present invention provides a security-enhanced wireless communication apparatus capable of determining an independent security policy for each security service and applying an independent security algorithm according to a security policy.

An embodiment of the present invention provides a security-enhanced wireless communication apparatus capable of controlling an authority to use a security accelerator or an authority to access a security partition according to a security policy.

In one general aspect of the present invention, there is provided a security-enhanced wireless communication apparatus including: a memory divided into a plurality of security partitions; a security accelerator configured to provide a plurality of security algorithms; and a processor configured to controlling a plurality of security element adaptors, which provides security system call Application Programming Interfaces (APIs) respectively linked with independent security service applications, and a virtual machine, which enforces security policies with respect to the security system call APIs and provides an authority to use the security accelerator or an authority to access a corresponding security partition according to a corresponding security policy.

The processor may be further configured to set one of the plurality of security element adaptors to a chip operating system for a smart card-related service, and another one of the plurality of security element adaptors to a file operating system for a remote file processing-related service.

The chip operating system may transmit a payment request to a payment authorizing device as a cloud message through a security system call API used in a smart card payment process, and store the payment request in a cloud server.

When authorization of the payment request is successfully received, the chip operating system may permit an access to a smart card security partition, which is one of the plurality of security partitions, through the security accelerator, so that a corresponding security service application is prevented from accessing a payment means stored in the smart card security partition.

The chip operating system may provide payment information, which is derived from the payment means and all encrypted by the security accelerator, to a payment processing device.

The file operating system may generate a partially-encrypted file through the security accelerator by using a security system call API in a direct Peer-To-Peer file transmission process, and transmit the partially-encrypted file to a file receiving and storing device.

The file operating system may generate the partially-encrypted file by dividing an original file into a plurality of segments and alternately arranging original segments and encrypted segments.

The processor may be further configured to set another one of the plurality of security element adaptors to a Push-To-Talk (PTT) operating system for a PTT service, the PTT operating system may interrupt direct P2P file transmission by a file operating system through a security system call API in use before a PTT transmission process and perform transmission of a variably-encrypted PTT message through the security accelerator prior to the direct P2P file transmission, and the variable encryption may be performed by a differential security algorithm according to a workload of the processor.

### BRIEF DESCRIPTION OF THE DRAWINGS

FIG. 1 is a diagram illustrating a security-enhanced wireless communication system according to an embodiment of the present invention.

FIG. 2 is a block diagram illustrating a wireless communication apparatus shown in FIG. 1.

FIG. 3 is a block diagram illustrating a security element shown in FIG. 2.

FIG. 4 is a flowchart illustrating a process of providing a smart card payment service by a wireless communication apparatus through a chip operating system according to an embodiment of the present invention.

FIG. 5 is a diagram illustrating an example in which a partially-encrypted file is generated in the file operating system.

FIG. 6 is a diagram for explanation of major functions provided by a security-enhanced wireless communication apparatus according to an embodiment of the present invention.

### DESCRIPTION OF EXEMPLARY EMBODIMENTS

A description of the disclosed technology is only embodiments for structural and/or functional descriptions. The scope of the disclosed technology should not be construed as being limited to the following embodiments. That is, the embodiments may be modified in various forms, and the scope of the disclosed technology should be understood as including equivalents which may realize the technical spirit.

Meanwhile, meanings of the terms described in the specification should be understood as follows.

Although the terms “first”, “second”, etc. may be used herein in order to differentiate one element from another element, the scope of the present invention is not to be construed as limited by these terms. For example, a first element could be termed a second element, and similarly, a second element could be termed a first element.

When it is said that one element is described as being “connected” to the other element, the one element may be directly connected to the other element, but it should be understood that a third element may be interposed between the two elements. In contrast, when it is said that one element is described as being “directly connected” to the other element, it should be understood that a third element is not interposed between the two elements. Meanwhile, the same principle applies to other expressions, such as “between \tilde{ }” and “just between \tilde{ }” or “adjacent to \tilde{ }” and “adjacent just to \tilde{ }”, which describe a relation between elements.

An expression of the singular number should be understood to include plural expressions, unless clearly expressed otherwise in the context. Terms, such as “include” or “have”, should be understood to indicate the existence of a set characteristic, number, step, operation, element, part, or a combination of them and not to exclude the existence of one or more other characteristics, numbers, steps, operations, elements, parts, or a combination of them or a possibility of the addition of them.

In each of steps, symbols (e.g., a, b, and c) are used for convenience of description, and the symbols do not describe order of the steps. The steps may be performed in order different from order described in the context unless specific order is clearly described in the context. That is, the steps may be performed according to described order, may be performed substantially at the same time, or may be performed in reverse order.

The present invention may be implemented as code that can be written on a computer-readable medium in which a program is recorded and thus read by a computer. The computer-readable medium includes all kinds of recording devices in which data is stored in a computer-readable manner. Examples of the computer-readable recording medium may include a read only memory (ROM), a random access memory (RAM), a compact disk read only memory (CD-ROM), a magnetic tape, a floppy disc, and an optical data storage device. In addition, the computer readable recording medium can be distributed to computer systems connected through a network and can be stored and executed as a computer readable code in a distributed mode.

Unless otherwise defined, all terms used herein have the same meaning as commonly understood by one of ordinary skill in the art to which this invention belongs. It should be further understood that terms, such as those defined in commonly used dictionaries, be interpreted as having a meaning that is consistent with their meaning in the context of the relevant art and this specification and will not to be interpreted in an idealized or overly formal sense unless expressly so defined herein.

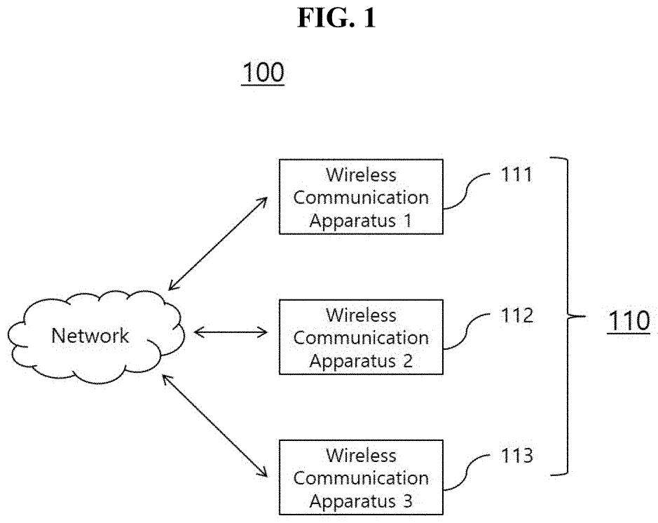

FIG. 1 is a diagram illustrating a security-enhanced wireless communication system according to an embodiment of the present invention.

Referring to FIG. 1, a security-enhanced wireless communication system (hereinafter, referred to as a wireless communication system) 100 may include at least two wireless communication apparatuses 110.

The wireless communication apparatuses 110 may correspond to Push-To-Talk (PTT) terminals capable of using a wireless communication service including real-time rapid point-to-point or point-to-multipoint communication. One wireless communication apparatus 111 out of the multiple wireless communication apparatuses 110 constructing the wireless communication system 100 may be connected to at least one wireless communication apparatus 112 or 113 of other wireless communication apparatuses 112 and 113 via a network and may exchange messages therewith.

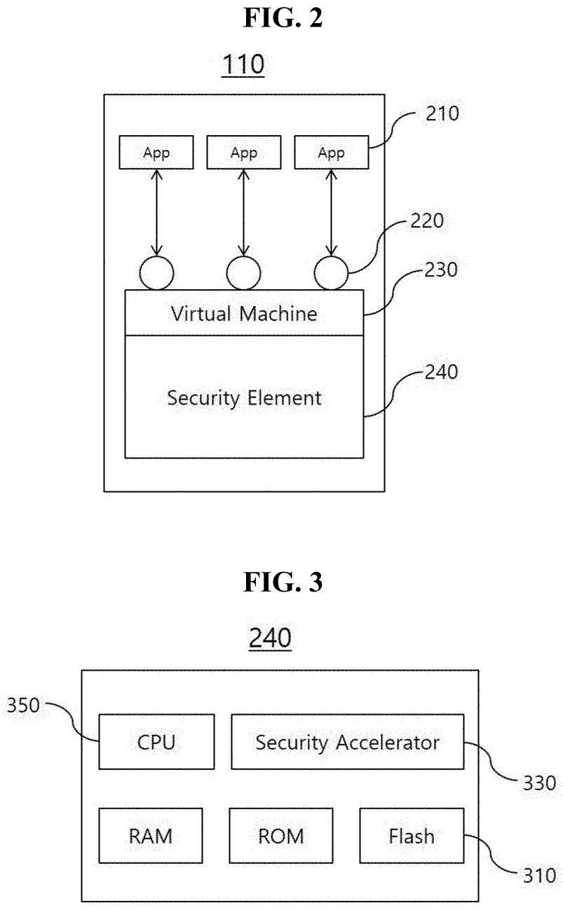

FIG. 2 is a block diagram illustrating a wireless communication apparatus shown in FIG. 1.

Referring to FIG. 2, a wireless communication apparatus 110 may include security service applications 210, security element adaptors 220, a virtual machine 230, and a security element 240.

The security service applications 210 may correspond to application programs for providing independent security services provided from the wireless communication apparatus 110. The wireless communication apparatus 110 may provide multiple security services, and, in order to provide each of the security services, the wireless communication apparatus 110 may include the security service applications 210 capable of independently performing an operation relating to each of the security services.

For example, the security service applications 210 may correspond to applications for providing a smart card solution service, a cloud network service, a P2P direct communication service, a P2P relay communication service, and a file transmission/storage service. However, the security service applications 210 are not limited thereto and may correspond to applications capable of directly performing various security services provided by the wireless communication apparatus 110.

The security service applications 210 may be basically installed in the wireless communication apparatus 110 or directly installed by the wireless communication apparatus 110 by downloading installation-related files via a network. The wireless communication apparatus 110 may access an update server (not shown in FIG. 1) to periodically check whether each of the security service applications 210 is updated, and, if an update file exists, the wireless communication apparatus 110 may automatically perform an update process.

The security element adaptors 220 may be linked to the security service applications 210 in one-to-one correspondence, and provide security system call Application Programming Interfaces (APIs). According to a security policy, the security element adaptors 220 may provide the security system call APIs to the security service applications 210 respectively linked to the corresponding security element adaptors 220.

The wireless communication apparatus 110 may generate a security element adaptor 220 upon execution of a particular security service application 210, and link the particular security service application 210 to the generated security element adaptor 220 in one-to-one correspondence. The wireless communication apparatus 110 may determine a security policy suitable for the particular security service application 210, and apply the determined security policy to the security element adaptor 220. When the particular security service application 210 completes operating and is terminated, the wireless communication apparatus 110 may delete the security element adaptor 220 linked to the particular security service application 210.

The virtual machine 230 may manage operations of the security element adaptors 220. The virtual machine 230 may be controlled by a processor (not shown in FIG. 2) included in the security element 240. The processor will be described in more detail with reference to FIG. 3.

The virtual machine 230 may enforce security policies with respect to the plurality of security element adaptors 230 and the security system call APIs. More specifically, according to security policies respectively applied to the plurality of security element adaptors 230, the virtual machine 230 may forcibly provide the security system call APIs to the security service applications 210.

In one embodiment, the virtual machine 230 may differentially determine security policies based on content of security services provided by the security service applications 210. More specifically, the virtual machine 230 may determine differential security policies in descending order of security levels which are required for the services based on properties of the services. For example, the virtual machine 230 may determine differential security policies in order of a smart card solution service, a file transmission/storage service, a P2P relay communication service, a P2P direct communication service, and a cloud network service.

According to a security policy, the virtual machine 230 may provide an authority to use a security accelerator (not shown in FIG. 2) or an authority to access a security partition of a memory (not shown in FIG. 2). The security accelerator and the memory will be described in detail with reference to FIG. 3.

The security element 240 may be in charge of overall security processing of the wireless communication apparatus 110. The security element 240 may provide an execution environment in which the virtual machine 230 is capable of operating, and the security element 240 may control operation of the virtual machine 230. The security element 240 may provide, through the virtual machine, an environment in which each security service application 210 is capable of operating. In a process in which a corresponding security application 210 is in execution, the security element 240 may control an authority to use the security accelerator and an authority to access the memory.

FIG. 3 is a block diagram illustrating the security element shown in FIG. 2.

The security element 240 may include a memory 310, a security accelerator 330, and a processor 350.

The memory 310 may be implemented as a flash memory, and may be divided into a plurality of security partitions. Here, each security partition may correspond to a part of the memory 310 and may be linked to a particular security service application 210 such that the use of a corresponding security partition may be restricted to provide a corresponding security service. The respective security partitions constituting the memory 310 may be linked to particular security service applications 210 under control of the virtual machine that is controlled by the security element 240.

The memory 310 may include an auxiliary memory device implemented as a non-volatile memory, such as a Solid State Disk (SSD) or a Hard Disk Drive (HDD), used to store overall data necessary for the wireless communication apparatus 110, and may include a main memory device implemented as a volatile memory such as a Random Access Memory (RAM). The memory 310 may be implemented independently from the RAM or a Read Only-Memory (ROM).

The security accelerator 330 may provide a plurality of security algorithms. A security policy may be applied to a security service application 210 by the virtual machine 230, and the security accelerator 330 is used according to the applied security policy, thereby performing an operation of a service to which a corresponding algorithm is applied. Using the virtual machine 230, the wireless communication apparatus 110 may control an authority to use, by which respective security service applications 210 are allowed to use the security accelerator 330.

The processor 350 may execute a security service application 210 associated with major functions of the wireless communication apparatus 110, manage the memory 310 read or written in the process of executing the security service application 210, and schedule a synchronization time between the volatile memory and the non-volatile memory in the memory 310. The processor 350 may control overall operations of the wireless communication apparatus 110 and may be electrically connected to the memory 310 and the security accelerator 330, thereby controlling a data flow therebetween. The processor 350 may be implemented as a Central Processing Unit (CPU) of the wireless communication apparatus 110.

In one embodiment, the processor 350 may set one of the plurality of security element adaptors 220 to a chip operating system for a smart card-related service, and another one thereof to be a file operating system for a remote file processing-related service. Here, the chip operating system may correspond to a system software necessary to provide a smart card solution service through the wireless communication apparatus 110, and the file operating system may correspond to a system software necessary to provide a file transmitting and storing service through the wireless communication apparatus 110. Under control of the virtual machine 230, the chip operating system and the file operating system may control operations of the security service applications 210 respectively associated thereto.

In one embodiment, in a payment process of a smart card, the chip operating system may transmit a payment request to a payment authorizing device as a cloud message via the security system call API and store the payment request in a cloud server. More specifically, when receiving a payment request signal based on smart card information stored in the wireless communication device 110, the chip operating system may perform security-processing on corresponding payment request information through the security system call API and transmit a security processing result to the payment authorizing device as a cloud message via a cloud network.

Here, the security processing by the chip operating system may correspond to an operation for protecting the payment request information in a manner in which payment request information including personal information is encrypted through the security system call API by applying a security algorithm. In this case, using the applied security algorithm according to a security policy enforced by the virtual machine 230, the chip operating system may transmit security-processed payment request information to a payment authorizing device as a cloud message via a could network. The payment authorizing device may be connected to the wireless communication apparatus 110 via the cloud network, and, when a payment request is received from a particular communication apparatus 110 while a different operation is ongoing, the payment authorizing device may store, in the cloud server, payment requests in order of receipt. The payment authorizing device may process the payment requests in order to be stored in the cloud server.

In one embodiment, when authorization of a payment request is successfully received, the chip operating system may permit an access to a smart card security partition, which is one of a plurality of security partitions, through the security accelerator 330, so that a corresponding security service application 210 is prevented from accessing a payment means existing in the smart card security partition.

A smart card payment service corresponds to a service for which highly enhanced security is required, and thus, even though the chip operating system is a security service application 210 providing a smart card payment service, an access to a smart card security partition where a payment means is stored is tightly restricted, thereby enhancing security.

In one embodiment, the chip operating system may provide payment information, which is derived from a payment means and all encrypted by the security accelerator 330, to a payment processing device. In order to protect the payment information derived from the payment means, the chip operating system may encrypt the payment information through the security accelerator 330 by applying a security algorithm having the tightest security. The encrypted payment information is provided to the payment processing device, and the payment processing device may perform payment processing based on the encrypted payment information.

In one embodiment, the file operating system may generate a partially-encrypted file through the security accelerator 330 by using a security system call API in a direct Peer-To-Peer (P2P) file transmitting process, and transmit the partially-encrypted file to a file receiving and storing device.

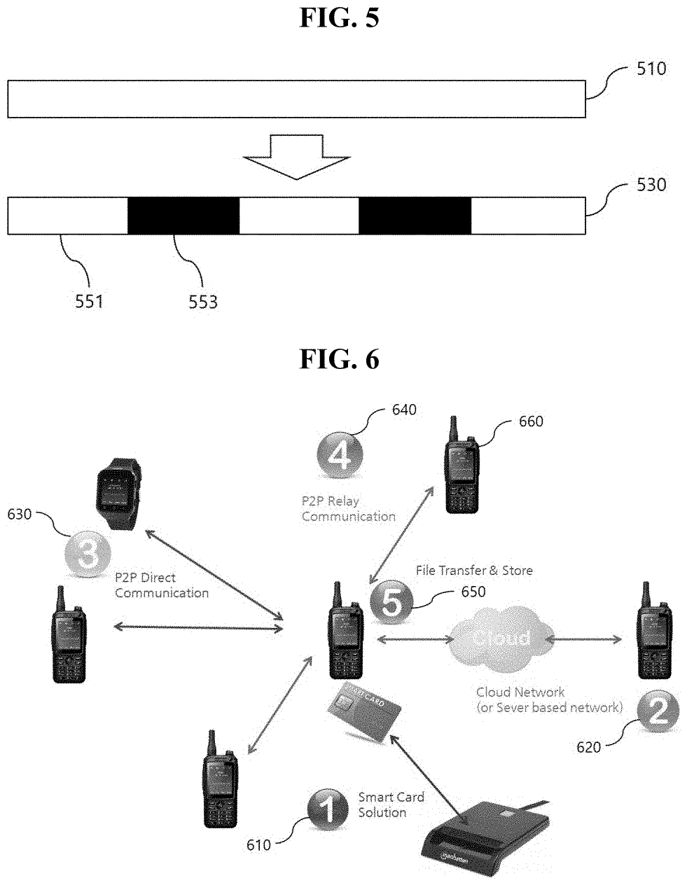

In an embodiment, the file operating system may divide an original file into a plurality of segments, and generate a partially-encrypted file by alternately arranging original segments and encrypted segments. FIG. 5 is a diagram illustrating an example in which a partially-encrypted file is generated in the file operating system. Referring to FIG. 5, the file operating system may divide an original file 510 into a plurality of segments 551 and 553. The file operating system may generate encrypted segments 553 through the security accelerator 330 by applying a security algorithm to some segments of the plurality of segments of the original file 510. The file operating system may generate a partially-encrypted file 530 by alternately arranging original segments 551 and encrypted segments 553.

In one embodiment, the file operating system may divide an original file into segments as many as the number calculated by the following equation, and the file operating system may generate the partially-encrypted file by alternately arranging original segments and encrypted segments.

$$N = k \times \frac{1}{P} \times F \times S \qquad [ Equation ]$$

Here, k denotes the proportionality constant, N denotes the number of divided segments, P denotes an amount of workload, F denotes a size of the original file, and S denotes a security level of a security policy. S may be normalized into a predetermined score according to the security level of the security policy, and S may have a higher score as the security level is higher.

The file operating system may divide an original file into a more number of segments as the size of the original file is greater, as the amount of workload of the processor is smaller, and as the security policy has a higher security level. The file operating system may encrypt some of segments, which are a result of division into an appropriate numeric value according to the above Equation, by applying a security algorithm, and the file operating system may generate a partially-encrypted file by alternately arranging original segments and encrypted segments, thereby enhancing security compared to transmitting the original file intact.

In one embodiment, the file operating system may perform encryption by applying a security algorithm to a whole algorithm file. In addition, the file operating system may encrypt only some of the original file in consideration of a workload of the processor 350, thereby compensating for a loss caused by the workload of the processor through enhancement of security. In conclusion, the file operating system may maintain stability of a file processing-related service at a constant level.

In an embodiment, the processor 350 may set another security element adaptor among the plurality of security element adaptors 220 to a PTT operating system for a Push-To-Talk (PTT) service. The PTT operating system may correspond to a system software necessary to provide a PTT service through the wireless communication apparatus 110.

In one embodiment, the PTT operating system may interrupt direct P2P file transmission by the file operating system through a security system call API in use before a PTT transmission process, and perform transmission of a variably-encrypted PTT message prior to the direct P2P file transmission through the security accelerator 330.

The PTT operating system may provide a PTT service independently of transmission of a direct P2P file, and, in the middle of the direct P2P file transmission process by the file operating system, the PTT operating system may stop the direct P2P file transmission and perform transmission of a PTT message prior to the direct P2P file transmission. The virtual machine 230 may determine not just operations of security element adaptors 220 but also priorities of the respective operations, and manage the operations of the security element adaptors 220 according to the priorities.

In one embodiment, the PTT operating system may generate a PTT message through the security accelerator 330 by applying variable encryption which is performed with a differential security algorithm according to a workload of the processor 350. More specifically, the PTT operating system may monitor a workload of the processor 350 in real-time, and, when the processor 350 has a great workload, the PTT operating system may perform by applying a security algorithm having a relatively low security level, and, when the processor 350 has a small workload, the PTT operating system may perform by applying a security algorithm having a relatively high security level. Accordingly, a PTT service independent of a workload of the processor 350 may be provided.

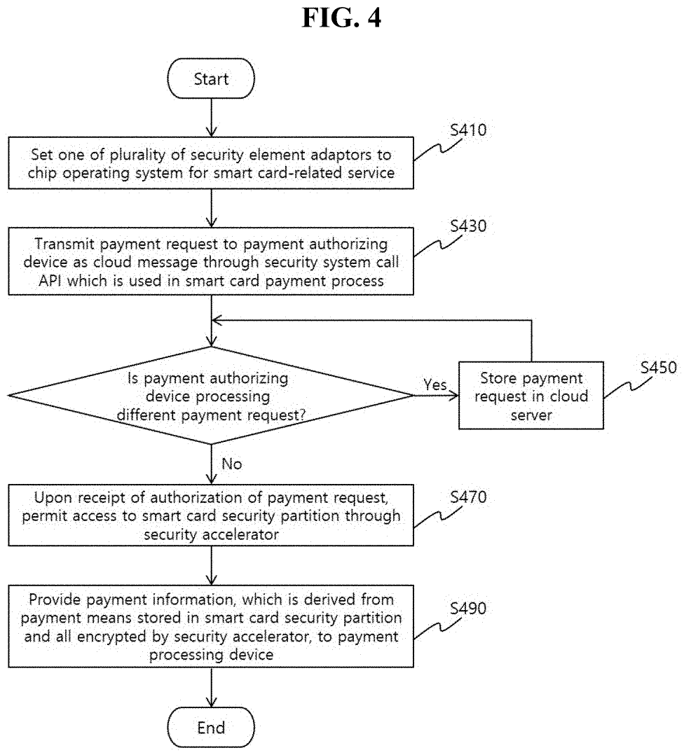

FIG. 4 is a flowchart illustrating a process of providing a smart card payment service by a wireless communication apparatus through a chip operating system according to an embodiment of the present invention.

Referring to FIG. 4, through the processor 350, the wireless communication apparatus 110 may set one security element adaptor among the plurality of security element adaptors 220 to a chip operating system for a smart card-related service (S410). The wireless communication apparatus 110 may allow the chip operating system to transmit a payment request to a payment authorizing device as a cloud message via a security system call API used in a smart card payment process (S430).

In this case, while the payment authorizing device having received the payment request is now processing another payment request, the received payment request may be stored a cloud server. Payment request messages stored in the cloud server may be processed sequentially in order to be stored.

When the chip operating system receives authorization of the payment request, the wireless communication apparatus 110 may permit an access to a smart card security partition through the security accelerator 330 (S470). The wireless communication apparatus 110 may provide payment information, which is derived from a payment means stored in the smart card security partition and all encrypted by the security accelerator 330, to a payment processing device (S490).

FIG. 6 is a diagram for explanation of major functions provided by a security-enhanced wireless communication apparatus according to an embodiment of the present invention.

Referring to FIG. 6, a wireless communication apparatus 660 may provide five security services and include security service applications 210 configured to perform operations for the respective security services independently of each other so as to provide the respective security services.

The wireless communication apparatus 660 may generate a security element adaptor 220 upon execution of a particular security service application 210, and link the particular security service application 210 to the generated security element adaptor 220 in one-to-one correspondence. The wireless communication apparatus 660 may manage operation of the security element adaptor 220 through a virtual machine 230.

Security services provided by the wireless communication apparatus 660 may correspond to a smart card solution service 610, a cloud network service 620, a P2P direct communication service 630, a P2P relay communication service 640, and a file transmission/storage service 650. The wireless communication apparatus 660 may determine an independent security policy for each security service, and apply an independent security algorithm according to each security policy.

Although the preferred embodiments of this application have been described above, a person having ordinary skill in the art will appreciate that this application can be modified and changed in various ways without departing from the spirit and scope of this application which are written in the claims below.

The disclosed technology can have the following effects. However, it does not mean that a specific embodiment should include all the following effects or include only the following effects, and thus it should not be understood that the scope of the disclosed technology is restricted by them.

A security-enhanced wireless communication apparatus according to an embodiment of the present invention is capable of determining an independent security policy for each security service, and apply an independent security algorithm according to each security policy.

A security-enhanced wireless communication apparatus according to an embodiment of the present invention is capable of controlling an authority to use a security accelerator or an authority to access a security partition according to a security policy.

What is claimed is:

1. A security-enhanced wireless communication apparatus comprising:
a memory divided into a plurality of security partitions;
a security accelerator configured to provide a plurality of security algorithms; and
a processor configured to controlling a plurality of security element adaptors, which provides security system call Application Programming Interfaces (APIs) respectively linked with independent security service applications, and a virtual machine, which enforces security policies with respect to the security system call APIs and provides an authority to use the security accelerator or an authority to access a corresponding security partition according to a corresponding security policy.

2. The security-enhanced wireless communication apparatus of claim 1, wherein the processor is further configured to set one of the plurality of security element adaptors to a chip operating system for a smart card-related service, and another one of the plurality of security element adaptors to a file operating system for a remote file processing-related service.

3. The security-enhanced wireless communication apparatus of claim 2, wherein the chip operating system transmits a payment request to a payment authorizing device as a cloud message through a security system call API used in a smart card payment process, and stores the payment request in a cloud server.

4. The security-enhanced wireless communication apparatus of claim 3, wherein, when authorization of the payment request is successfully received, the chip operating system permits an access to a smart card security partition, which is one of the plurality of security partitions, through the security accelerator, so that a corresponding security service application is prevented from accessing a payment means stored in the smart card security partition.

5. The security-enhanced wireless communication apparatus of claim 4, wherein the chip operating system provides payment information, which is derived from the payment means and all encrypted by the security accelerator, to a payment processing device.

6. The security-enhanced wireless communication apparatus of claim 2, wherein the file operating system generates a partially-encrypted file through the security accelerator by using a security system call API in a direct Peer-To-Peer file transmission process, and transmits the partially-encrypted file to a file receiving and storing device.

7. The security-enhanced wireless communication apparatus of claim 6, wherein the file operating system generates the partially-encrypted file by dividing an original file into a plurality of segments and alternately arranging original segments and encrypted segments.

8. The security-enhanced wireless communication apparatus of claim 1, wherein the processor is further configured to set another one of the plurality of security element adaptors to a Push-To-Talk (PTT) operating system for a PTT service,
wherein the PTT operating system interrupts direct P2P file transmission by a file operating system through a security system call API in use before a PTT transmission process, and performs transmission of a variably-encrypted PTT message through the security accelerator prior to the direct P2P file transmission, and
wherein the variable encryption is performed by a differential security algorithms according to a workload of the processor.
